(19) United States
(12) Patent Application Publication
(10) Pub. No.: US 2014/0295842 A1
(43) Pub. Date: Oct. 2, 2014

(54) METHOD FOR HANDOVER OF MOBILE APPARATUS AND COMMUNICATION DEVICE FOR THE SAME

(71) Applicant: ELECTRONICS AND TELECOMMUNICATIONS RESEARCH INSTITUTE, DAEJEON (KR)

(72) Inventors: Sung Woo CHOI, Daejeon (KR); Jun Hyeong KIM, Daejeon (KR); Il Gyu KIM, Chungcheongbuk-Do (KR)

(73) Assignee: ELECTRONICS AND TELECOMMUNICATIONS RESEARCH INSTITUTE, DAEJEON (KR)

(21) Appl. No.: 14/224,704

(22) Filed: Mar. 25, 2014

(30) Foreign Application Priority Data
Mar. 27, 2013 (KR) 10-2013-0032662

(51) Int. Cl. H04W 36/24

(52) U.S. Cl. CPC H04W 36/24
USPC 455/436

(57) ABSTRACT

Provided are a method for handover of mobile apparatus, a communication device for the same, and a mobile apparatus using the same. A communication device of a mobile apparatus may comprise a first antenna unit, a second antenna unit, a first signal processing part receiving a handover command indicating to handover from a first beam which maintains connection with the mobile apparatus through the first antenna unit to a second beam, and storing information about the first beam, and a second signal processing part performing handover from a third beam which maintains connection with the mobile apparatus through the second antenna unit to the first beam by using the information about the first beam. Therefore, a procedure for handover to a new beam area may be simplified.

### CLAIM FOR PRIORITY

This application claims priority to and the benefit of Korean Patent Application No. 2013-0032662 filed on Mar. 27, 2013 in the Korean Intellectual Property Office (KIPO), the entire contents of which are hereby incorporated by reference.

### BACKGROUND

1. Technical Field

Example embodiments of the present invention relate in general to a method for handover of mobile apparatus and a communication device for the mobile apparatus using the method, and more specifically, to a method for handover of mobile apparatus operating in a wireless communication system using directional beams, a communication device of mobile apparatus using the same, and a mobile apparatus using the communication apparatus.

2. Related Art

A wireless communication network comprises a plurality of radio units (RU), a digital unit (DU) managing and controlling the plurality of RUs, and at least one terminal (user equipment). The radio units and the digital unit may be connected through optic cables, and each of the radio units may perform a role of remote antenna.

In wireless mobile communication, when a terminal moves far from a current cell and quality of transmitting and receiving data becomes worse, a terminal should maintain communications by moving a new cell which can provide better quality of transmitting and receiving data. A procedure as described above may be referred to as ‘handover’. The procedures of handover may frequently happen when the terminal move fast or when a radius of a cell is small in such a case of millimeter wave bands.

Meanwhile, in a mobile communication system such as Long Term Evolution (LTE), several steps are required to be performed in order for a terminal to access a new cell. First, a terminal should acquire frequency and symbol synchronization in the new cell, and obtain an identifier (ID) of the new cell. The terminal can demodulate downlink signal transmitted from the new cell using the cell ID. Also, a cell may transmit cell-specific reference signals periodically in all frequency bands. A terminal may measure strengths of the cell-specific reference signals, and select and access a cell having the highest signal strength. For this, a terminal may measure strengths of cell-specific reference signals from a plurality of cells. At this time, strength of reference signal to be measured may be a Reference Signal Received Power (RSRP) or a Received Signal Strength Indication (RSSI), etc.

The terminal may decode a channel broadcasted by the selected cell to obtain cell-specific system information for accessing the selected cell.

The terminal should transmit measured signal strengths of a current cell and neighbor cells periodically according to request of a base station. The terminal should obtain a cell ID of a new cell in order to demodulate cell-specific reference signal of the new cell, and measure signal strength of cell-specific reference signal of the new cell. Thus, the terminal should operate a cell search block performing the above procedures persistently, and maintain a list of cells. Also, even after synchronization with a new cell is established, cell system information should be decoded in order to communicate with a cell.

Since the above procedures are controlled through signaling of a terminal, latency of data using transmission channel may occur. Therefore, the complexity of the above procedures should be simplified.

### SUMMARY

Accordingly, example embodiments of the present invention are provided to substantially obviate one or more problems due to limitations and disadvantages of the related art.

Example embodiments of the present invention provide a communication device for a mobile apparatus.

Example embodiments of the present invention also provide a mobile apparatus comprising the communication device.

Example embodiments of the present invention also provide a method for handover of the mobile apparatus, which is performed in the communication device of the mobile apparatus.

In some example embodiments, a communication device of a mobile apparatus receiving beams transmitted from at least one radio unit may comprise a first antenna unit, a second antenna unit, a first signal processing part receiving a handover command indicating to handover from a first beam which maintains connection with the mobile apparatus through the first antenna unit to a second beam, and storing information about the first beam, and a second signal processing part performing handover from a third beam which maintains connection with the mobile apparatus through the second antenna unit to the first beam by using the information about the first beam.

Here, the information about the first beam may include an identity of the first beam and system information related to the first beam.

Here, the first signal processing part may receive the handover command through a radio unit managing the first beam, and the handover command may be transmitted from a digital unit controlling a plurality of radio units which include the radio unit managing the first beam.

Here, the first antenna unit may be installed in a forward position of moving direction of the mobile apparatus, and the second antenna unit may be installed in a backward position of moving direction of the mobile apparatus.

Here, the first signal processing part may measure signal strengths of the first beam and a plurality of handover candidate beams, and transmit information about the signal strengths to the radio unit managing the first beam.

Here, the information about the signal strengths may include reference signal received power (RSRP) values or received signal strength indication (RSSI) values of reference signals included in the first beam and the plurality of handover candidate beams.

In other example embodiments, a mobile apparatus receiving beam transmitted from at least one radio unit may comprise a communication device which includes a first antenna unit and a second antenna unit, receives an handover command indicating to handover from a first beam which maintains connection with the mobile apparatus through the first antenna unit to a second beam, stores information about the first beam, and uses the information about the first beam to perform handover from a third beam which maintains connection with the mobile apparatus through the second antenna unit to the first beam.

Here, the information about the first beam may include an identity of the first beam and system information related to the first beam.

Here, the first antenna unit may be installed in a forward position of moving direction of the mobile apparatus, and the second antenna unit may be installed in a backward position of moving direction of the mobile apparatus.

In still other example embodiments, a method for handover of a mobile apparatus including a plurality of antenna units may comprise transmitting, to a digital unit, information about a first beam which maintains connection with the mobile apparatus through the first antenna unit, and information about a plurality of handover candidate beams; receiving an handover command indicating to handover from the first beam to a second beam from the digital unit, and storing the information about the first beam; and performing handover from a third beam which maintains connection with the mobile apparatus through a second antenna unit to the first beam by using the information about the first beam.

Here, the information about the first beam and the information about the plurality of handover candidate beams may include information about signal strengths of the first beam and the plurality of handover candidate beams.

Here, the information about the signal strengths may include reference signal received power (RSRP) values or received signal strength indication (RSSI) values of reference signals included in the first beam and the plurality of handover candidate beams.

Here, the first signal processing part may receive the handover command through a radio unit managing the first beam, and the handover command may be transmitted from a digital unit controlling a plurality of radio units which include the radio unit managing the first beam.

Here, the information about the first beam may include an identity of the first beam and system information related to the first beam.

Here, the performing handover may further comprise receiving a handover command indicating to handover to the first beam from the digital unit; transmitting a random access signal to the digital unit; receiving an uplink acknowledgement signal from the digital unit; and performing transmitting/receiving data with the digital unit using the system information related to the first beam.

### BRIEF DESCRIPTION OF DRAWINGS

Example embodiments of the present invention will become more apparent by describing in detail example embodiments of the present invention with reference to the accompanying drawings, in which:

FIG. 1 is a block diagram to illustrate a configuration of a mobile communication system according to the present invention;

FIG. 2 is a conceptual diagram to illustrate communication links between radio units and a mobile apparatus according to the present invention;

FIG. 3 is a conceptual diagram to illustrate a situation of mobile apparatus handover according to an example embodiment;

FIG. 4 is a conceptual diagram to illustrate a situation of mobile apparatus handover according to another example embodiment;

FIG. 5 is a block diagram to illustrate a communication device for a mobile apparatus according to an example embodiment of the present invention;

FIG. 6 is a flow chart to explain a method for handover of mobile apparatus according to an example embodiment of the present invention; and

FIG. 7 is a flow chart to explain a method for handover of mobile apparatus according to another example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

However, there is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “mobile apparatus” used herein may include a communication terminal or a communication device in it. Alternatively, the communication device (or terminal) may be attached to the mobile apparatus. Also, the “mobile apparatus” may be referred to as an apparatus moving along a predetermined restricted path (such as motorway, railway, etc.)

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), mobile node, mobile, or other terms. Various embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited thereto.

The term “base station” used herein generally denotes a fixed or mobile point that communicates with a terminal, and may be referred to as a Node-B, evolved Node-B (eNB), base transceiver system (BTS), access point, relay, femto-cell, and other terms.

Hereinafter, preferred embodiments of the present invention will be described in more detail with reference to the accompanying drawings. To facilitate overall understanding of the invention, the same reference numerals in the drawings denote the same elements, and repetitive description of the same elements is omitted.

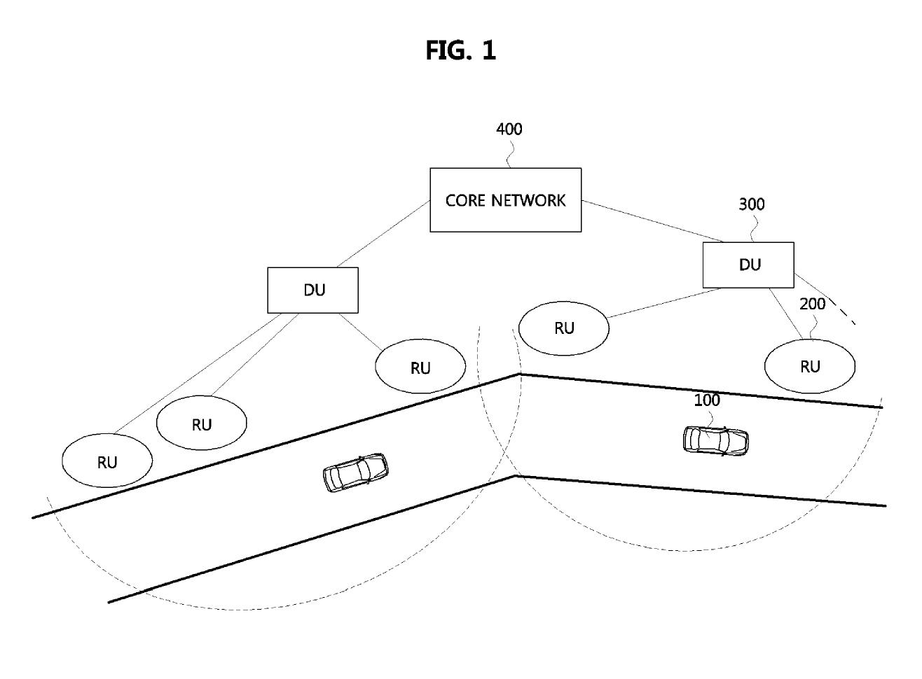

An environment to which the present invention can be applied is a mobile communication system comprising a plurality of radio units and at least one digital unit, which is a communication network providing mobile communication services in motorways or railways. As an example, a mobile communication system is presented in FIG. 1.

FIG. 1 is a block diagram to illustrate a configuration of a mobile communication system according to the present invention.

Referring to FIG. 1, a mobile communication system according to the present invention may comprise a core network (CN) 400, a plurality of digital units (DU) 300 which are connected to the CN, and a plurality of radio units (RU) 200 which are connected to each corresponding DU. For convenience of explanation, a mobile apparatus 100 according to the present invention (for example, a car having a communication device) is assumed to exist in a motorway 10.

A plurality of RUs 200 may be arranged around the motorway 10, and each of RUs may provide corresponding services for a predetermined region of the motor way. The service coverages of the RUs may be overlapped so as to provide service to all regions of the motor way.

That is, a mobile communication system depicted in FIG. 1 may be configured to include a base station and a plurality of RUs corresponding to each cell, resolve a problem of coverage holes by the configuration, and support many terminals.

The radio unit (RU) 200 is an apparatus acting a role of remote antenna for the digital unit (DU) 300, and connected to the DU 300 via an optic cable. The digital unit (DU) 300 acts a role of a base station, and manages the RUs 200 and a plurality of terminals which access the RU 200. The DU 300 may be connected to the CN 400, through which users may access internet network.

A method according to the present invention is assumed to be based on the mobile communication network illustrated in FIG. 1, and the mobile communication network is assumed to use frequency bands above millimeter wave bands.

Usually, millimeter wave may mean electromagnetic wave having wave length of millimeter unit. Thus, millimeter wave bands may be frequency bands ranging from 30 GHz to 300 GHz. The advantages in using millimeter wave bands due to characteristics of millimeter wave (for example, short wave length) are making antenna and apparatus using it small and light, and making use of wide bandwidth possible so as to achieve high data throughput.

Since millimeter wave has very high straightness and is very sensitive to various environmental factors, it has not been used mainly for long-range wireless communication. However, according to depletion of frequency resources, various methods for utilizing millimeter wave bands are being studied recently.

In millimeter wave bands, coverage angle of antenna is relatively smaller than that of conventional mobile communication frequency bands, that is, only several degrees to several tens of degrees. Accordingly, communications between the RU 200 and the terminal (for example, a communication device of the mobile apparatus 100) are possible only when the RU 200 and the terminal are located within radiation angles of each other. In addition, since there are not effects of reflected waves due to very high straightness of millimeter wave, it is difficult to establish independent links even when techniques of multiple antennas (for example, Multiple Input Multiple Output (MIMO)) are used for a single base station and a single terminal.

However, when a terminal has a plurality of signal processing parts, each of signal processing parts may be connected to different radio unit so that a terminal may maintain multiple radio links by using directivity of beams radiated from radio units. For example, in FIG. 1, a car (mobile apparatus) 100 may maintain a radio link with a radio unit located in a path for which the car is heading while the car maintains another radio link with another radio unit located in a path through which the car has already passed.

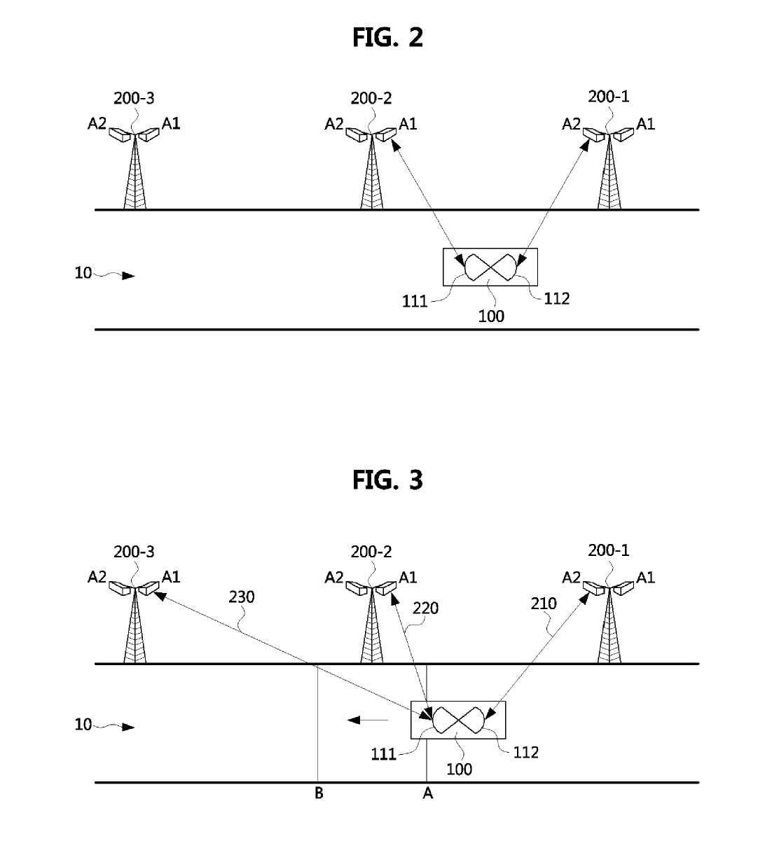

FIG. 2 is a conceptual diagram to illustrate communication links between radio units and a mobile apparatus according to the present invention.

As shown in FIG. 2, a mobile apparatus (for example, a car) 100 may be moving to a direction (for example, forward direction; from right to left of the picture). Radio units 200-1, 200-2, and 200-3 may be installed in surrounding areas of a motorway 10 or in center of the motorway, and cover both directions, forward direction and backward direction of the mobile apparatus in reference to a moving direction of the mobile apparatus.

In an example embodiment of the present invention shown in FIG. 2, it is assumed that communication link is guaranteed when conditions of line of sight (LOS) are satisfied using millimeter wave. The mobile apparatus 100 is located between a first radio unit 200-1 and a second radio unit 200-2. The mobile apparatus 100 establishes a communication link with a first radio unit 200-1 via a second antenna unit 112, and a communication link with a second radio unit 200-2 via a first antenna unit 111.

The present invention may be applied to an inter-beam handover case in which a mobile apparatus moves and enters into a new beam area in a handover situation depicted in FIG. 2.

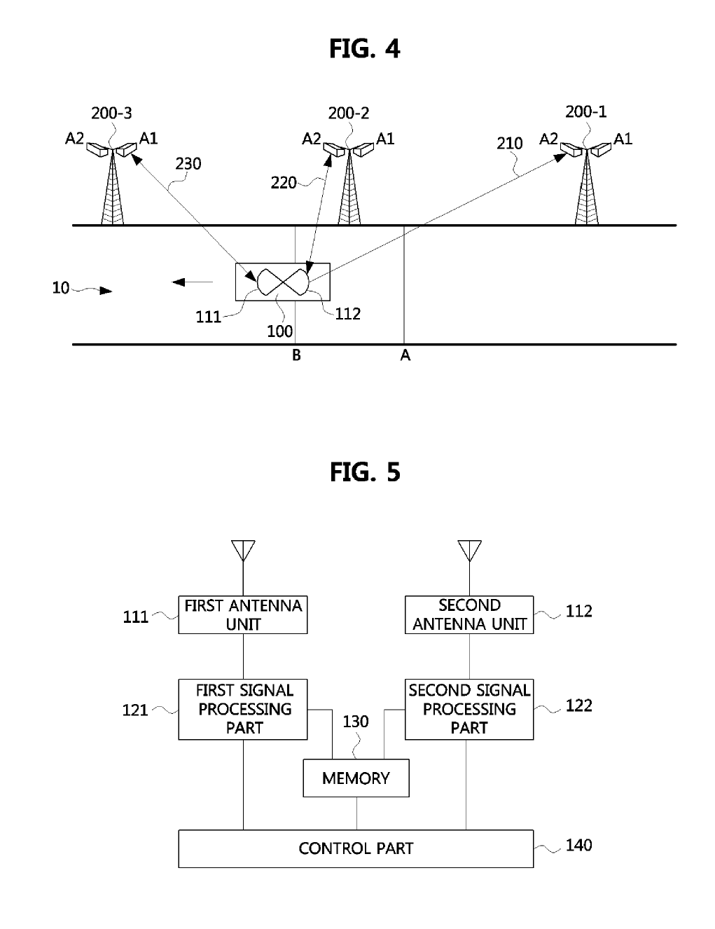

As considered in an example embodiment of the present invention, in an environment in which a mobile apparatus moves along a straight path, two kinds of handovers may occur as shown in FIGS. 3 and 4.

FIG. 3 is a conceptual diagram to illustrate a situation of mobile apparatus handover according to an example embodiment.

The situation illustrated in FIG. 3 is for showing that the mobile apparatus moves further in a forward direction as compared to that of FIG. 2. Referring to FIG. 3, when the mobile apparatus 100 becomes close to the second radio unit 200-2, the first antenna unit 111 of the mobile apparatus 100 may handover from the second radio unit 200-2 to the third radio unit 200-3 at point A.

FIG. 4 is a conceptual diagram to illustrate a situation of mobile apparatus handover according to another example embodiment.

The situation illustrated in FIG. 4 is for showing that the mobile apparatus moves further in a forward direction as compared to that of FIG. 3. Referring to FIG. 4, when the mobile apparatus 100 arrives at point B, the second antenna unit 112 of the mobile apparatus 100 may handover from the first radio unit 200-1 to the second radio unit 200-2.

As explained through FIGS. 3 and 4, when the mobile apparatus 100 passes by the radio unit 200-2, handovers may occur two times.

Meanwhile, in mobile communication system such as a Wideband Code Division Multiple Access (WCDMA) and a Long Term Evolution (LTE), a set of procedures are required to be performed when a terminal access a new cell in a situation such as handover.

First, a terminal measure states of radio links of a current cell and neighbor cells periodically. A base station receives information about states of radio links from the terminal, and determines whether to perform handover of the terminal or not based on the received information. The states of radio links may be measured as received signal strengths of cell-specific reference signals. The cell-specific reference signals are used for channel estimation, and transmitted through all service frequency bands in a predetermined frequency and time intervals. The terminal can identify states of radio links (radio channels) by measuring cell-specific reference signals transmitted by base stations. Also, a set of cell search procedures are required for a terminal operating in a LTE system to receive cell-specific reference signals.

In order that a terminal can be synchronized with a cell, a terminal should receive synchronization signal from a base station. The base station transmits information needed for time and frequency synchronization through the synchronization signal. In a LTE system, the synchronization signal consists of primary synchronization signal (PSS) and secondary synchronization signal (SSS). A terminal demodulates both signals so as to acquire a cell identity (ID), which can be used to demodulate cell specific reference signals. The above described procedure for acquiring the cell ID may be referred to as a cell search procedure.

For PSS and SSS synchronization as described above, a terminal should have a necessary hardware block in a digital signal processing part.

On the other hand, a base station determines whether to perform handover of a corresponding terminal by using values reported by the terminal, Reference Signal Received Power (RSRP) values of current cell and neighbor cells of the terminal. The base station may transmit a handover command including information about random access for a new cell to the terminal when the base station determines to perform handover of the terminal. The terminal transmits random access signal to a base station of the new cell in order to access the new cell, and the base station of the new cell transmits an uplink acknowledgment signal to the terminal. The terminal can establish uplink synchronization with the base station using uplink synchronization information received through the uplink acknowledgement signal. Then, the terminal synchronized with the base station may transmit data to the base station.

After handover, the terminal which accessed the new cell may obtain system information of a mobile communication system belonging to the new cell. The system information may be obtained by demodulating information broadcasted periodically by the base station. The above procedure may be referred to as a system information acquisition procedure.

In the present invention, proposed is a method of simplifying the cell search procedure and the system information acquisition procedure for the above explained handover situations. That is, a method for simplifying a set of procedures needed for the handover situation by utilizing directional beams and characteristics of mobile apparatus moving along a restricted path (for example, motorway or railway).

FIG. 5 is a block diagram to illustrate a communication device for a mobile apparatus according to an example embodiment of the present invention.

For example, the mobile apparatus according to an example embodiment of the present invention may have a communication device comprising two antenna units 111 and 112, two signal processing parts 121 and 122, a memory 130, and a control part 140.

A first signal processing part 121 of the communication device may be connected to a first antenna unit 111, and a second signal processing part 122 of the communication device may be connected to a second antenna unit 112. The signal processing part 121 and 122 may be connected to the memory 130 and the control part 140. The control part 140 may be connected to the two signal processing parts 121 and 122 and the memory 130, and control overall operations of the communication device.

One of the two signal processing parts may be a forward signal processing part which is responsible for forward direction of the mobile apparatus, and the other of the two signal processing parts may be a backward signal processing part which is responsible for backward direction of the mobile apparatus.

The forward signal processing part may measure RSRP of a serving beam which is currently connected to the communication device, and additionally perform a procedure of searching new beams. When a new beam is searched, the new beam is added to a set of candidate beams. Also, the forward signal processing part transmits information about signal strengths of the serving beam and the candidate beams to the digital unit 300 through an antenna of the serving beam.

Then, when the forward signal processing part receives a handover command from the digital unit, the forward signal processing part stores an ID of the serving beam and the system information related to the serving beam in the memory, and sets a candidate beam among the set of candidate beams as a new serving beam. Through the new serving beam, the communication device may acquire new system information broadcasted by the digital unit 300.

Meanwhile, when the new beam ID is stored in the memory, the backward signal processing part may set the beam corresponding to the new beam ID as a candidate beam, and measure signal strength of the candidate beam. Also, the backward signal processing part transmits information about signal strengths of the serving beam and the candidate beam to the digital unit 300 through an antenna of the serving beam. Then, when the backward signal processing part receives a handover command from the digital unit, the backward signal processing part sets the candidate beam as a serving beam, and acquires the system information stored in the memory 130.

The communication device of mobile apparatus may receive signals inputted through the first antenna unit 111 and the second antenna unit 112 which are installed respectively in forward direction and backward direction of the mobile apparatus, and demodulate the signals by using the two signal processing parts.

However, installation positions of the first antenna unit 111 and the second antenna unit 112 may not be limited to a forward position and a backward position of the moving direction of the mobile apparatus as explained above. Alternatively, two antenna units may be arranged with an appropriate distance, and receive two beams which are apart from each other to the extent that they do not interfere with each other.

The communication device of mobile apparatus may demodulate different input signals, or achieve high signal to noise gain by receiving the same data and processing them using two antenna units and two signal processing parts. Also, although an example in which the communication device of mobile apparatus comprises two signal processing parts is explained in FIG. 5, in other example embodiment of the present invention, the communication device of mobile apparatus may use a single signal processing part, and utilize a link having better quality selectively.

On the other hand, as explained in FIGS. 3 and 4, the mobile apparatus 100 and the digital unit 300 need procedures for supporting handover of the mobile apparatus 100 at the points A and B. In a case of using a conventional handover rule, the communication device of the mobile apparatus 100 may need all of above-explained procedures—a cell search procedure, an uplink synchronization procedure, and a system information acquisition procedure—in order to communicate with a new cell.

According to the present invention, a cell search procedure and a system information acquisition procedure at the points A and B shown in FIGS. 3 and 4 may be performed differently from the conventional procedures. Since the mobile apparatus moves to a predetermined direction, redundant operations can be prevented by using a feature that the two signal processing parts, with a time lag, perform handover procedures with the same radio unit.

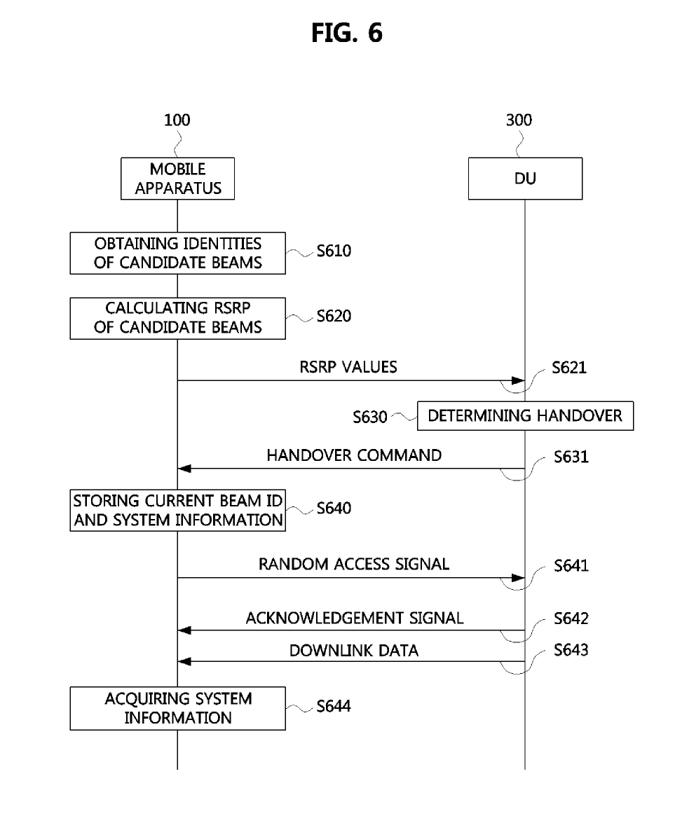

FIG. 6 is a flow chart to explain a method for handover of mobile apparatus according to an example embodiment of the present invention.

As explained above, the first signal processing part 121 is connected to the first antenna unit 111, and the second signal processing part 122 is connected to the second antenna unit 112. A beam which is connected to a current link is referred to as a serving beam, and a searched beam RSRP of which is being calculated is referred to as a candidate beam.

FIG. 6 is for explaining detail procedures in handover of mobile apparatus at the point A illustrated in FIGS. 3 and 4, an operation of the mobile apparatus 100 explained through FIG. 6 may be understood mainly as an operation of the first signal processing part 121.

The mobile apparatus 100 measures RSRPs of a plurality of candidate beams, and transmit the measured RSRPs to the digital unit 300. When the handover is determined to be performed, the digital unit 300 may select one of the candidate beams as a serving beam.

More specifically, before the mobile apparatus 100 arrives at the point A, the mobile apparatus 100 may obtain an ID of beam transmitted from an antenna A1 of a third radio unit 200-3 through a beam (cell) search procedure at S610. The beam (cell) search procedure may be understood as a procedure of decoding synchronization signal of corresponding beam. The mobile apparatus 100 calculates RSRP values using IDs of new candidate beams acquired by the beam search procedure at S620. At this time, although not shown in FIG. 6, the mobile apparatus 100 has already calculated RSRP of the serving beam (a beam linked with an antenna unit A1 of the second radio unit 200-2).

The mobile apparatus 100 transmit a signal including RSRPs of a serving beam and candidate beams through the first antenna unit 111. The signal is received by the antenna unit A1 of the second radio unit 200-2 operating as a current serving beam (beam 220 of FIGS. 3 and 4), and transferred to the digital unit 300 at S621.

The digital unit 300 which receives RSRPs of a serving beam and candidate beams may determine whether to perform handover or not according to a handover determination rule. For example, as shown in FIG. 6, when a handover to a beam 230 is determined, the digital unit 300 transmits, to the mobile apparatus 100, a handover command indicating handover to the beam 230 through an antenna A1 of the radio unit 200-2 at S631.

When the mobile apparatus receives the handover command, the first signal processing part 121 stores system information and information about beam IDs of the second radio unit 200-2 (for example, in FIG. 6, an ID of beam 220 and system information) in the memory at S640, for a later use of the second processing part. Then, the mobile apparatus 100 may transmit random access signal through the third radio unit 200-3. The digital unit 300 which receives it may transmit an uplink acknowledgement signal through the third radio unit 200-3 to the mobile apparatus 100 at S642.

Accordingly, uplink synchronization procedure is completed. After the above procedure, the first signal processing part 121 of the mobile apparatus 100 may perform transmitting/receiving data with the digital unit 300 through an antenna A1 of the third radio unit 200-3. At S644, the mobile apparatus 100 acquires new system information from downlink channel or signal transmitted through a newly established link, that is, a beam 230.

Procedures explained through FIG. 6 are procedures belonging to the first handover performed when the mobile apparatus 100 passes by the second radio unit 200-2 shown in FIGS. 3 and 4.

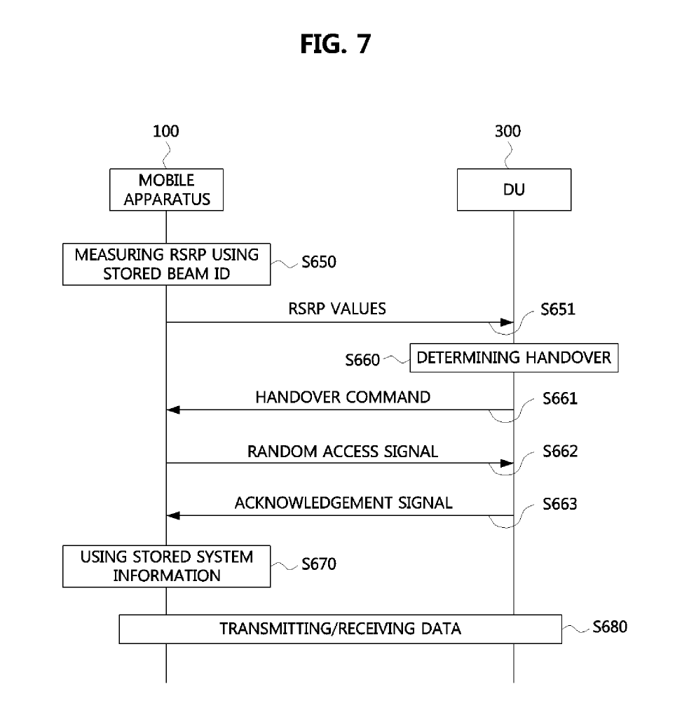

FIG. 7 is a flow chart to explain a method for handover of mobile apparatus according to another example embodiment of the present invention.

As explained above, the first signal processing part 121 is connected to the first antenna unit 111, and the second signal processing part 122 is connected to the second antenna unit 112. A beam which is connected to a current link is referred to as a serving beam, and a searched beam RSRP of which is being calculated is referred to as a candidate beam.

FIG. 7 is for explaining detail procedures in handover of mobile apparatus at the point B illustrated in FIGS. 3 and 4, an operation of the mobile apparatus 100 explained through FIG. 7 may be understood mainly as an operation of the second signal processing part 122.

In the example embodiment shown in FIG. 6, the mobile apparatus 100, which performs handover at point A, measures RSRPs of a plurality of candidate beams, and transmit the measured RSRPs to the digital unit 300.

However, in a handover procedure shown in FIG. 7, the mobile apparatus 100 which performs handover at point B, does not measure RSRPs of a plurality of candidate beams. At S650, instead of measuring RSRPs of a plurality of candidate beams, the second processing part 122 of the mobile apparatus 100 measures RSRP using an ID of beam of the second radio unit 200-2, which is stored in the memory 130. That is, in the handover procedure shown in FIG. 7, the mobile apparatus 100 does not demodulate synchronization signals of candidate beams.

Before the mobile apparatus 100 which passed the point A arrives at point B, the second signal processing part 122 of the mobile apparatus 100 transmit RSRPs of signals received from the first radio unit 200-1 (beam 210 in an example embodiment of FIG. 7) and the second radio unit 200-2 (beam 220 in an example embodiment of FIG. 7) to the digital unit 300 through an antenna A2 of the first radio unit 200-1 at S651. In an example embodiment of FIG. 7, the mobile apparatus 100 transmits a RSRP of beam 220 to the digital unit 300, not RSRPs of a plurality of candidate beams as in the example embodiment of FIG. 6.

That is, in the example embodiment of FIG. 7, a candidate beam may be a candidate beam predicted and selected according to restricted moving path of the mobile apparatus 100 as opposed that a candidate beam among a plurality of candidate beams is selected by the digital unit in the example embodiment of FIG. 6. This feature of the present invention may simplify handover procedures, and reduce unnecessary overhead in processing and signaling.

When RSRPs of a serving beam and a candidate beam selected by the mobile apparatus are received, the digital unit 300 determines whether to perform handover or not according to a handover determination rule. For example, in the example embodiment of FIG. 7, handover to beam 220 is determined to be performed at S660.

When handover is determined to be performed, the digital unit 300 transmits a hand over command to the second signal processing part 122 through an antenna A2 of the first radio unit 200-1 at S661. In an uplink synchronization procedure, the second signal processing part 122 of the mobile apparatus 100 may transmit random access signal to the second radio unit 200-2. The digital unit 300 which receives it from the mobile apparatus 100 may transmit an uplink acknowledgement signal through the second radio unit 200-2 to the mobile apparatus 100 at S663. Accordingly, the mobile apparatus 100 completes uplink synchronization procedure with the digital unit 300 through the second radio unit 200-2, and the second signal processing part 122 of the mobile apparatus 100 may perform transmitting/receiving data with the second radio unit 200-2.

In addition, the mobile apparatus 100 needs to acquire system information of the second radio unit 200-2 in order to perform transmitting/receiving data with the digital unit 300. For this, the second signal processing part 122 of the mobile apparatus 100 reads out system information of beam 220 (beam of the second radio unit 200-2) stored in the memory 130 at S670. In other words, in a method for handover according to an example embodiment of the present invention, separate procedure of demodulating signal for acquiring system information about new beam which is a target of handover.

The mobile apparatus 100 may perform transmitting/receiving data with the digital unit through the second radio unit managing beam 220 by using system information related to beam 220 which has been already stored in the memory. Accordingly, the second handover procedure performed when the mobile apparatus passes by the second radio unit 200-2 is completed.

According to an example embodiment explained through FIG. 7, in the second handover procedure, a beam search procedure and a system information acquisition procedure are substituted with simplified procedures.

In other words, although hardware for demodulating synchronization signal should be operated in order to perform beam search in the conventional handover procedure, information about a target beam of handover may be predicted and utilized according to the present invention.

Also, although system information transmitted periodically through downlink should be demodulated for acquiring system information of digital unit in the conventional handover procedure, a step of demodulating signals transmitted through downlink can be omitted by using stored system information.

According to the present invention explained above, in a wideband communication system supporting motorway or railway by using directional beams, when a mobile apparatus moves into a new beam area, a procedure for handover to the new beam area may be simplified so that power consumption of the communication device of the mobile apparatus may be decreased and data throughput may be increased by reducing overhead of control signaling.

While the example embodiments of the present invention and their advantages have been described in detail, it should be understood that various changes, substitutions and alterations may be made herein without departing from the scope of the invention.

What is claimed is:

1. A communication device of a mobile apparatus receiving beams transmitted from at least one radio unit, comprising:
a first antenna unit;
a second antenna unit;
a first signal processing part receiving a handover command indicating to handover from a first beam which maintains connection with the mobile apparatus through the first antenna unit to a second beam, and storing information about the first beam; and
a second signal processing part performing handover from a third beam which maintains connection with the mobile apparatus through the second antenna unit to the first beam by using the information about the first beam.

2. The communication apparatus of claim 1, wherein the information about the first beam includes an identity of the first beam and system information related to the first beam.

3. The communication apparatus of claim 1, wherein the first signal processing part receives the handover command through a radio unit managing the first beam, and the handover command is transmitted from a digital unit controlling a plurality of radio units which include the radio unit managing the first beam.

4. The communication apparatus of claim 1, wherein the first antenna unit is installed in a forward position of moving direction of the mobile apparatus, and the second antenna unit is installed in a backward position of moving direction of the mobile apparatus.

5. The communication apparatus of claim 1, wherein the first signal processing part measures signal strengths of the first beam and a plurality of handover candidate beams, and transmits information about the signal strengths to the radio unit managing the first beam.

6. The communication apparatus of claim 1, wherein the information about the signal strengths includes reference signal received power (RSRP) values or received signal strength indication (RSSI) values of reference signals included in the first beam and the plurality of handover candidate beams.

7. A mobile apparatus receiving beam transmitted from at least one radio unit, comprising a communication device which includes a first antenna unit and a second antenna unit, receives an handover command indicating to handover from a first beam which maintains connection with the mobile apparatus through the first antenna unit to a second beam, stores information about the first beam, and uses the information about the first beam to perform handover from a third beam which maintains connection with the mobile apparatus through the second antenna unit to the first beam.

8. The mobile apparatus of claim 7, wherein the information about the first beam includes an identity of the first beam and system information related to the first beam.

9. The mobile apparatus of claim 7, the first antenna unit is installed in a forward position of moving direction of the mobile apparatus, and the second antenna unit is installed in a backward position of moving direction of the mobile apparatus.

10. A method for handover of a mobile apparatus including a plurality of antenna units, the method comprising:
transmitting, to a digital unit, information about a first beam which maintains connection with the mobile apparatus through the first antenna unit, and information about a plurality of handover candidate beams;
receiving an handover command indicating to handover from the first beam to a second beam from the digital unit, and storing the information about the first beam; and
performing handover from a third beam which maintains connection with the mobile apparatus through a second antenna unit to the first beam by using the information about the first beam.

11. The method of claim 10, wherein the information about the first beam and the information about the plurality of handover candidate beams include information about signal strengths of the first beam and the plurality of handover candidate beams.

12. The method of claim 10, wherein the information about the signal strengths includes reference signal received power (RSRP) values or received signal strength indication (RSSI) values of reference signals included in the first beam and the plurality of handover candidate beams.

13. The method of claim 10, wherein the first signal processing part receives the handover command through a radio unit managing the first beam, and the handover command is transmitted from a digital unit controlling a plurality of radio units which include the radio unit managing the first beam.

14. The method of claim 10, wherein the information about the first beam includes an identity of the first beam and system information related to the first beam.

15. The method of claim 14, wherein the performing handover comprises:
receiving a handover command indicating to handover to the first beam from the digital unit;
transmitting a random access signal to the digital unit;
receiving an uplink acknowledgement signal from the digital unit; and
performing transmitting/receiving data with the digital unit using the system information related to the first beam.
